(19) United States
(12) Patent Application Publication
(10) Pub. No.: US 2002/0043939 A1
(43) Pub. Date: Apr. 18, 2002

(54) Antenna marker lamp

(76) Inventors: Philip C. Roller, Ashville, NY (US); Timothy DiPenti, Russell, PA (US); Scott Troutman, Jamestown, NY (US)

Correspondence Address: Byron A. Bilicki, Esq., THE BILICKI LAW FIRM, P.C., Furniture Mart Building, Suite 1000, 111 West Second Street, Jamestown, NY, 14701, US

(21) Appl. No.: 09/976,503

(22) Filed: Oct. 12, 2001

Related U.S. Application Data
(60) Provisional application No. 60/239,677, filed on Oct. 12, 2000.

(51) Int. Cl. H05B 37/02

(52) U.S. Cl. 315/149; 315/56

(57) ABSTRACT

A marker lamp for vehicles that combines a global positioning system (GPS) antenna and a cellular antenna. The marker lamp uses light emitting diodes as light sources. The lens of the present invention utilizes two sets of optical elements, one set collimates and spread the light from the light emitting diodes and the second set reflects light from outside sources. Both sets of optics contribute to produce a marker lamp with the required light intensity and distribution according to industry standards. The marker lamp conceals a GPS antenna and/or a cellular antenna to help track and direct the vehicle during travel and to facilitate communication with the vehicle operator. The GPS tracking system and cellular components are at least partially by the marker lamp.

### PRIORITY STATEMENT

This application claims the benefit of U.S. Provisional Application No. 60/239,677 filed Oct. 12, 2000.

### FIELD OF INVENTION

The present invention is generally related to lamps for vehicles and to global positioning systems used in vehicular tracking, and is related more particularly to a marker lamp that combines a global positioning system (GPS) antenna and a cellular antenna.

### BACKGROUND OF THE INVENTION

Marker lights contribute to the safe operation of motor vehicles, especially large trucks or tractor-trailers. A marker lamp will be used on a vehicle to indicate overall length and height. The marker lamp is useful by making a vehicle more visible and detectable to other motorists. Another technological advantage now available to vehicle users is better and newer communications technology, in that a number of mobile communication systems exist. The use of cellular phones to report emergencies, breakdowns and such is useful but it lacks the convenience of accurate pinpoint reports of the location of the vehicle. More recently Global Positioning Systems (GPS) and vehicle information and communications systems (VICS) have become available. These systems help to navigate, locate and communicate the vehicle's position, even while the vehicle is in motion.

Companies such as freight and courier services have a need for tracking the vehicles in their fleet. The global Positioning System acts to improve logistics of a fleet, heighten security, reduce operating costs, improve scheduling and dispatching and eventually can improve customer satisfaction. The present invention allows dispatchers and headquarters for these vehicles to be in constant contact with the operators of the vehicles and constantly monitor the progress and whereabouts of the vehicle. These systems also assist law enforcement agencies in the location and recovery of stolen vehicles.

The increase in communication devices has also increased the number of antennas to be used on a vehicle. Most of these antennas are installed on the car body or instrument panel of the vehicle. Also the installation of these antennas is most often an optional feature, usually performed after the assembly of the vehicle is completed, making the installation of such antennas difficult and expensive.

An additional problem is created by the visibility of GPS and cellular antennas. Such visibility creates awareness of the presence of GPS and cellular units in vehicles and consequently makes these units an attractive target for thieves. Also, exposure of antennas on a vehicle leads to their easy accessibility, allowing vehicle thieves to easily destroy or disable an antenna and thereby destroy the ability to locate a vehicle through the Global Positioning System. Therefore, there is a need to reduce the visibility of GPS and/or cellular antennas.

### SUMMARY OF EMBODIMENTS OF THE INVENTION

Embodiments of the present invention combine a marker lamp with an antenna adapted to receive and radiate cellular signals and/or an antenna adapted to receive and radiate Global Positioning System signals. Certain embodiments also include a housing that provides antenna mounting members and a light emitting diode mounting member. The light emitting diodes (LEDs) in certain embodiments are mounted on a printed circuit board which in turn is fixedly secured to the LED mounting member. The cellular antenna and the GPS antenna are operatively connected to a power source through a control circuit that allows communication from the user's control console to the antennas. The LEDs are operatively connected to the printed circuit board which in turn is operatively connected to a power source. A lens is mounted onto the housing such that the lens is adapted to transmit the light emitted from at least one light emitting diode. In certain embodiments, the above antennas are covered by the lens. The lens and the housing can be equipped with mounting holes to allow the lamp to be mounted to the vehicle.

These above mentioned characteristics and other objects of the invention will become more apparent from the following description of the alternate embodiments.

Accordingly, it is an object of the present invention to provide a combination marker lamp/global positioning-cellular antennas for vehicles.

### BRIEF DESCRIPTION OF THE DRAWINGS

Other aspects, objects, and advantages of the present invention will become evident on reading the following best mode for carrying out the invention, given by way of example and made with reference to the accompanying drawings, in which:

FIG. 1 is a perspective front view of the marker lamp of the present invention.

FIG. 2 is a top view of the marker lamp.

FIG. 3 is a cross-sectional view of the lens of the present invention.

FIG. 4 is a top perspective view of the housing of the present invention.

### DETAILED DESCRIPTION OF PREFERRED EMBODIMENTS

For the purpose of promoting an understanding of the present invention, reference will be made to the present invention as illustrated in the drawings. It will nevertheless be understood that no limitations of the scope of the invention is thereby intended, such alterations as using a different color for the lens of the invention or advances in LED technology could reduce the number of LEDs needed to accomplish the function of the invention could provide additional alterations which would fall within the spirit and scope of the invention described herein. Some of the possible alterations will be mentioned in the following description.

The drawings will be described in detail. For the ease of the reader, like reference numerals designating identical or similar part will remain consistent through the drawings.

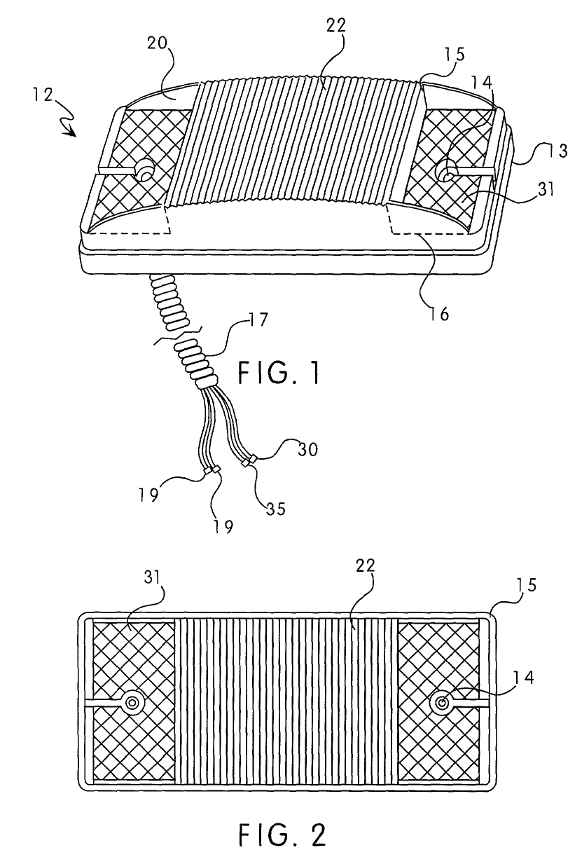

FIG. 1 is a perspective view of the marker lamp of the present invention. Preferably, the lens 15 of lamp 12 is made of amber polycarbonate, although other colors of polycarbonate can be used without detracting from the function of the invention. It should also be noted that other materials may be used to create the lens of the present invention so long as those materials will allow light to pass through those materials. The marker lamp 12 comprises a housing 13 and a lens 15. In one embodiment, the lamp preferably includes at least two mounting holes 14 for fixedly attaching the lamp to the vehicle by means of screws or post. It should be understood that other means of mounting or attachment found in the art can be use to secure the lamp to the vehicle. The antenna 18 and power lines 19 are operatively connected to the lamp. To ensure safety, the antenna and power lines can be encased in a sheath 17, which will prevent accidental damage to the lines. In an alternate embodiment, the sheath is made of flexible insulating plastic well known in the art. The center section 22 of the lens 15 of the marker lamp 12 is raised and forms a dome. In the most preferred embodiment of the present invention, the center section 22 is flanked on either side by a set of optics 31. The optics 31 are utilized to reflect light from outside sources. The lens 15 also possesses walls 20 and 16 which surround the diamond shaped optics 31 on opposite sides of the optical elements.

FIG. 2 shows a front view of an alternate embodiment of the marker lamp. In this figure, the optics on lens 15 can be better appreciated. The center optics 22 is a series of cylindrical prisms. The center optics 22 collimates the light and then distributes the light. The center optics 22 is flanked by two sets of diamond shaped optics 31. The diamond shaped optics 31 reflect light from outside sources. The light is fanned back to the outside due to the 90 degree angles present in the diamond shaped optics 31.

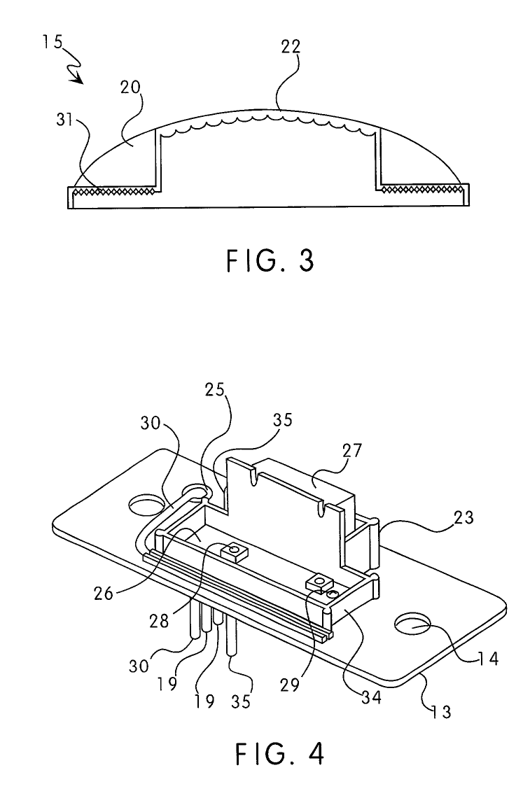

FIG. 3 is a cross-sectional view of the lens 15. The diamond shaped optics 31 and cylindrical prisms 22 can be observed. The lens 15 has a wall 20 connecting the top 22 and lower 31 optical sections of the lens 15.

In FIG. 4, the housing 13 can be observed with all the components in an alternate embodiment. The housing provides an LED mounting member 34 and a mounting member 23. The LED mounting member 34 accommodates the circuit board 26 with light emitting diodes 28 mounted thereon. The LED mounting member 34 further has a screw 29 to secure the circuit board 26 to the LED mounting member 34. One of ordinary skill in the art will readily appreciate that other means can be used to secure the circuit board 26 to the LED mounting member 34. The mounting member 23 holds the cell antenna 27, which allows the transmittal and receipt of the various signals. In an alternate embodiment, the cell antenna 27 and the GPS antenna are combined into one antenna unit. In an alternate embodiment, the LEDs, the circuit board, the cellular antenna and GPS antenna are potted with epoxy for protection and to avoid movement of these parts. The antenna mounting member 36 is a slight depression extending to hole 25 which allows the GPS antenna 30 access to the control module located in the vehicle. In an alternate embodiment the GPS antenna 30 can be integral with the housing.

The description presented in the embodiments is not intended to demonstrate all of the possible arrangements and modifications to the design. For those skilled in the art, changes will be apparent that will fall within the scope of the present invention.

What is claimed is:

1. A lamp comprising:
a housing;
a printed circuit board;
at least one light emitting diode operatively connected to said printed circuit board;
an antenna adapted to receive and radiate global positioning system signals, said antenna received by said housing; and,
a lens adapted to transmit said light emitted from said at least one light emitting diode.

2. A lamp according to claim 1, further comprising potting material, said potting material covering said printed circuit board and at least part of said at least one light emitting diode.

3. A lamp according to claim 2, wherein said potting material is an epoxy material.

4. A lamp comprising:
a housing;
a printed circuit board;
at least one light emitting diode operatively connected to said printed circuit board;
an antenna adapted to receive and radiate global positioning system signals, said antenna received by said housing; and,
a lens adapted to transmit said light emitted from said at least one light emitting diode, said lens having at least one optical element.

5. A lamp according to claim 4 further comprising (i) a first plurality of optical elements; each optical element of said first plurality adapted to collimate said light emitted from said at least one light emitting diode; and (ii) a second plurality of optical elements; each optical element of said second plurality adapted to reflect light from at least one external light source.

6. A lamp according to claim 5 wherein said first plurality of optical elements comprises at least one cylindrical prism and said second plurality of optical elements comprises at least one diamond shaped optic.

7. A lamp according to claim 4 further comprising potting material, said potting material covering said printed circuit board and at least part of said at least one light emitting diode.

8. A lamp according to claim 7, wherein said potting material is an epoxy material.

9. A lamp comprising:
a housing;
a printed circuit board;
at least one light emitting diode operatively connected to said printed circuit board;
an antenna adapted to receive and radiate cellular signals, said antenna received by said housing; and,
a lens adapted to transmit said light emitted from said at least one light emitting diode.

10. A lamp according to claim 9, further comprising potting material, said potting material covering said printed circuit board and at least part of said at least one light emitting diode.

11. A lamp according to claim 10, wherein said potting material is an epoxy material.

12. A lamp comprising:
a housing;
a printed circuit board;
at least one light emitting diode operatively connected to said printed circuit board;
an antenna adapted to receive and radiate cellular signals, said antenna received by said housing; and,
a lens adapted to transmit said light emitted from said at least one light emitting diode, said lens having at least one optical element.

13. A lamp according to claim 12 further comprising (i) a first plurality of optical elements; each optical element of said first plurality adapted to collimate said light emitted from said at least one light emitting diode; and (ii) a second plurality of optical elements; each optical element of said second plurality adapted to reflect light from at least one external light source.

14. A lamp according to claim 13 wherein said first plurality of optical elements comprises at least one cylindrical prism and said second plurality of optical elements comprises at least one diamond shaped optic.

15. A lamp according to claim 12, further comprising potting material, said potting material covering said printed circuit board and at least part of said at least one light emitting diode.

16. A lamp according to claim 15, wherein said potting material is an epoxy material.

17. A lamp comprising:
a housing;
a printed circuit board;
at least one light emitting diode as a light source operatively connected to said printed circuit board;
a first antenna adapted to receive and radiate global positioning system signals, said first antenna received by said housing;
a second antenna adapted to receive and radiate cellular signals, said second antenna received by said housing; and,
a lens adapted to transmit said light emitted from said at least one light emitting diode.

18. A lamp according to claim 17 further comprising potting material, said potting material covering said printed circuit board and at least part of said at least one light emitting diode.

19. A lamp according to claim 18 wherein said potting material is an epoxy material.

20. A lamp comprising:
a housing;
a printed circuit board;
at least one light emitting diode as a light source operatively connected to said printed circuit board;
a first antenna adapted to receive and radiate global positioning system signals, said first antenna received by said housing;
a second antenna adapted to receive and radiate cellular signals, said second antenna received by said housing; and,
a lens adapted to transmit said light emitted from said at least one light emitting diode, said lens having at least one optical element.

21. A lamp according to claim 20 further comprising (i) a first plurality of optical elements; each optical element of said first plurality adapted to collimate said light emitted from said at least one light emitting diode; and (ii) a second plurality of optical elements; each optical element of said second plurality adapted to reflect light from at least one external light source.

22. A lamp according to claim 21 wherein said first plurality of optical elements comprises at least one cylindrical prism and said second plurality of optical elements comprises at least one diamond shaped optic.

23. A lamp according to claim 20 further comprising potting material, said potting material covering said printed circuit board and at least part of said at least one light emitting diode.

24. A lamp according to claim 23 wherein said potting material is an epoxy material.

25. A lamp comprising:
a housing;
a printed circuit board:
at least one light emitting diode as a light source operatively connected to said printed circuit board;
an antenna unit received by said housing, said antenna unit comprising
a first antenna adapted to receive and radiate global positioning system signals, and
a second antenna adapted to receive and radiate cellular signals, and,
a lens adapted to transmit said light emitted from said at least one light emitting diode.

26. A lamp according to claim 25 further comprising potting material, said potting material covering said printed circuit board and at least part of said at least one light emitting diode.

27. A lamp according to claim 26 wherein said potting material is an epoxy material.

28. A lamp comprising:
a housing;
a printed circuit board:
at least one light emitting diode as a light source operatively connected to said printed circuit board;
an antenna unit received by said housing, said antenna unit comprising
a first antenna adapted to receive and radiate global positioning system signals, and
a second antenna adapted to receive and radiate cellular signals, and,
a lens adapted to transmit said light emitted from said at least one light emitting diode, said lens having at least one optical element.

29. A lamp according to claim 28 further comprising (i) a first plurality of optical elements; each optical element of said first plurality adapted to collimate said light emitted from said at least one light emitting diode; and (ii) a second plurality of optical elements; each optical element of said second plurality adapted to reflect light from at least one external light source.

30. A lamp according to claim 29 wherein said first plurality of optical elements comprises at least one cylindrical prism and said second plurality of optical elements comprises at least one diamond shaped optic.

31. A lamp according to claim 28 further comprising potting material, said potting material covering said printed circuit board and at least part of said at least one light emitting diode.

32. A lamp according to claim 31 wherein said potting material is an epoxy material.
